(19) United States
(12) Patent Application Publication
(10) Pub. No.: US 2019/0043665 A1
(43) Pub. Date: Feb. 7, 2019

(54) SILICONE EXTENSION FOR AN IGNITION COIL FOR INTERNAL COMBUSTION ENGINES, IGNITION COIL COMPRISING SAID SILICONE EXTENSION AND METHOD OF ASSEMBLY FOR SAID IGNITION COIL

(71) Applicant: ELDOR CORPORATION S.P.A., Orsenigo (Como) (IT)

(72) Inventors: Simone PENNATI, Orsenigo (Como) (IT); Pasquale FORTE, Orsenigo (Como) (IT)

(21) Appl. No.: 16/076,650

(22) PCT Filed: Feb. 27, 2017
(86) PCT No.: PCT/IB2017/051126

§ 371 Date: Aug. 8, 2018

(30) Foreign Application Priority Data
Mar. 2, 2016 (IT) 102016000022011

(51) Int. Cl. H01F 38/12; H01B 3/46; H01T 13/04

(52) U.S. Cl. CPC H01F 38/12; H01F 2038/125; H01T 13/04; H01B 3/465

(57) ABSTRACT

A silicone extension for an ignition coil for internal combustion engines including an elongated tubular body extending along its main direction between a first end portion, shaped to be engaged in a container containing electrical/electronic means for the generation of high voltage electrical energy, and a second end portion shaped to accommodate the insulating body of an ignition spark plug, wherein the tubular body is made of self-lubricating silicone rubber.

The present invention relates to a silicone extension for an ignition coil for internal combustion engines, an ignition coil comprising said silicone extension and a method of assembling said ignition coil.

Therefore, the present invention finds particular application in the automotive field, in particular in the manufacture of those so-called pen or plug top coils, which are subject to particular positioning and dimensional constraints.

The prior art coils have a conductive element that connects the electronic components, i.e. the core of the coil, with the spark plug, wherein the elongate-shaped (pen-like) conductive element is, in turn, inserted in a tubular body of insulating material.

This tubular body, commonly known as “extension”, has the purpose of insulating the conductive element during the discharge phase, in which it reaches very high voltages and temperatures.

In this respect, over the years special silicone rubbers have been developed for the manufacture of the extensions, which rubbers are capable of maintaining their performance even under the boundary conditions imposed by the operation and the position of the coil.

The most widely used polymer in silicone rubber formulations for high voltage external insulation applications is polydimethylsiloxane (PDMS), consisting of an inorganic backbone of alternate silicon and oxygen atoms; the methyl groups are attached to the silicon atoms to form the repeating unit of the polymer.

This polydimethylsiloxane is used in these applications mainly because of its good resistance to high temperatures and high voltages.

In addition, further advantages of typically used silicone rubbers are the presence of a hydrophobic surface, low surface and mass conductivities, fracture strength in a wide temperature range, which give them several advantages over other types of rubber.

Unfortunately, however, the extensions currently on the market are not able to ensure that their properties will be maintained over time, as they are subject to strong deterioration due to thermal ageing and to the so-called “corona discharge effect”.

Thermal ageing mainly undermines the elastic and toughness properties of the rubber.

The corona discharge effect, instead, is a phenomenon that develops in the presence of free electrons and high voltages (as in the case of coils), generating discharges on the surface of the insulating element, which impair its performance.

The main effects of these discharges result in:
a reduction in hydrophobicity, with a consequent substantial decrease in the resistance to deterioration;
mechanical erosion by ion bombardment of the surfaces;
a silica layer on the surface, resulting in increased susceptibility to the formation of cracks;
reduced mechanical performance (in a manner similar to thermal ageing).

These problems are deeply felt especially during maintenance, when the spark plug/coil must be disassembled and the extension handled by the operator.

In this respect, one must not forget a further problem, linked to the tendency of the silicone to stick to the spark plug (sticking) that, as time and work cycles pass, increases until it becomes inevitable.

To overcome this problem, conventional coils require the application of a copious amount of a suitable, often expensive lubricant, which, while making the extension more durable, does not solve the problem at the root.

In fact, because of thermal ageing as well as of the corona discharge effect, silicone rubbers available on the market today tend to dry up and absorb the lubricant, essentially nullifying its effect, thus sticking to the ceramic spark plug (with consequent handling problems for the operator during maintenance).

Therefore, the object of the present invention is to provide a silicone extension for an ignition coil for internal combustion engines, an ignition coil comprising said silicone extension and a method of assembling said ignition coil, which overcome the above-mentioned drawbacks of the prior art.

In particular, one object of the present invention is to provide a silicone extension for an ignition coil for internal combustion engines with improved performance, especially in terms of duration.

A further object of the present invention is to provide a silicone extension for an ignition coil for internal combustion engines and a coil comprising said extension having an increased resistance to the corona discharge effect.

A still further object of the present invention is to provide a silicone extension for an ignition coil for internal combustion engines and a coil comprising said extension capable of reducing the thermal ageing effects, in particular with reference to the sticking phenomena.

A further object of the present invention is to provide a method of assembling/installing an ignition coil for internal combustion engines, which is simplified and reliable.

Said objects are achieved by means of a silicone extension for an ignition coil for internal combustion engines having the features of one or more of the subsequent claims from 1 to 8, of an ignition coil for internal combustion engines having the features of claim 9 and of a method of assembling/installing an ignition coil for internal combustion engines having the features of claim 10.

In particular, the silicone extension comprises an elongated tubular body extending along its main direction between a first end portion, shaped to be engaged in a container containing electrical/electronic means for the generation of high voltage electrical energy, and a second end portion shaped to accommodate an insulating body of a spark plug.

According to a primary aspect of the present invention, the tubular body of the extension is made of self-lubricating silicone rubber.

Advantageously, this eliminates the need to apply a lubricant on the insulating body powering the spark plug prior to the engagement of the extension, thus simplifying the assembly procedure.

Moreover, the inherent characteristic of the material ensures that the same is not subject to deterioration/ageing over time.

Furthermore, the use of a self-lubricating silicone rubber not only allows for obviating the need to lubricate the spark plug, but also greatly improves the resistance of the material to the corona discharge effect, an unprecedented event.

Proof of this is the increased resistance of the material to test cycles more than doubled in duration compared to known materials, reaching 2000 hours of electrical reliability testing capable of ionizing the air (corona discharge effect) without a significant deterioration in the material (compared to 1000 hours of the known materials).

Preferably, the silicone rubber used has a composition comprising an oil content of between 0.5% and 10% by weight, more preferably between 1% and 6% by weight.

In the preferred embodiment, the silicone rubber used preferably has a composition comprising an oil content of between 1% and 5% by weight, more preferably of about 3% by weight.

In other words, the oil content within the same is of between 0.005 x and 0.1 x, preferably between 0.01 x and 0.06 x, wherein “x” is the weight of the extension.

In the preferred embodiment, the oil content within the extension is of between 0.01 x and 0.05 x, preferably of 0.03 x.

It should be noted that, in the preferred embodiment, the oil is of the diathermic type, i.e. a high molecular weight oil, preferably petroleum-derived, the weight of which allows for a high heating thereof without generating decomposition.

Advantageously, in this way, the oil molecules inside the silicone composition are maintained unchanged during operation of the coil, without decomposing and without degradation of the material.

The ignition coil according to the invention therefore comprises a container having a connecting protrusion and containing electrical/electronic means for the generation of high voltage electrical energy, a spark plug having an insulating body, a connection conductive element extending along the main direction between a first end, connected to said electrical/electronic means, and a second end, connected to said spark plug.

The silicone extension, made of self-lubricating silicone rubber, is thus positioned so that the connecting protrusion of the container is engaged in the first end portion of the tubular body, the insulating body of the spark plug is engaged in said second end portion of the tubular body, and said connection conductive element is housed in the cavity.

Advantageously, this structure is both reliable and easy to assemble.

In this respect, it should be noted that the present invention also relates to a method of assembling and installing an ignition coil for an internal combustion engine comprising the following steps (not necessarily listed in chronological order):
connecting the first end of the conductive element to the electrical/electronic means at the protrusion of the container;
connecting the second end of the conductive element to the insulating body of the spark plug;
inserting the conductive element in the cavity of the tubular body of the silicone extension;
engaging the connecting protrusion of the container in the first end portion of the tubular body of the extension;
engaging, without the use of lubricants, the insulating body of the spark plug in the second end portion of the tubular body of the silicone extension.

Special attention should therefore be paid to the last, greatly simplified step of the method, wherein the application of lubricant (other than the oil of which the extension is made) is totally removed, with consequent advantages in terms of both performance and quality (and cleaning).

These and other features, and the inherent advantages will become more apparent from the following illustrative, and therefore not limiting, description of a preferred, thus not exclusive, embodiment of a silicone extension for an ignition coil for internal combustion engines and of a coil comprising said extension as shown in the accompanying drawings, wherein:

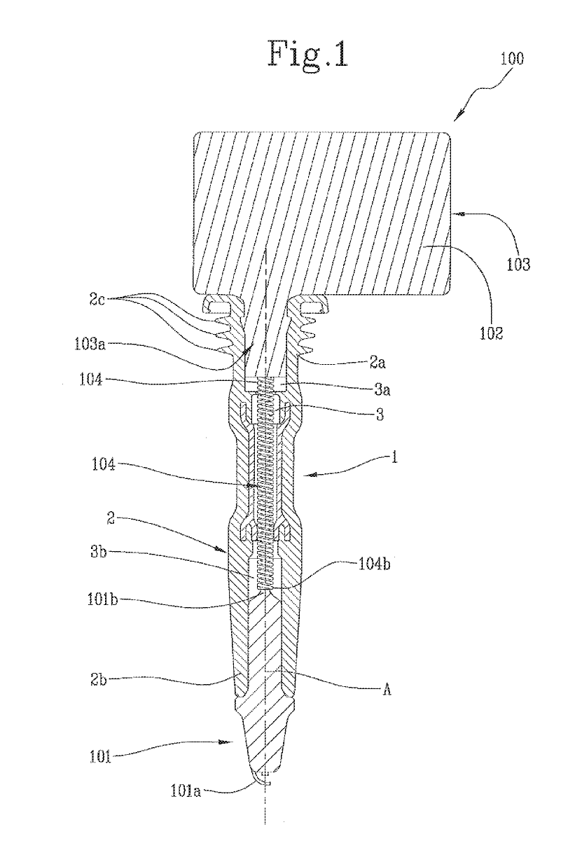

FIG. 1 shows a perspective view of an embodiment of a silicone extension according to the present invention;

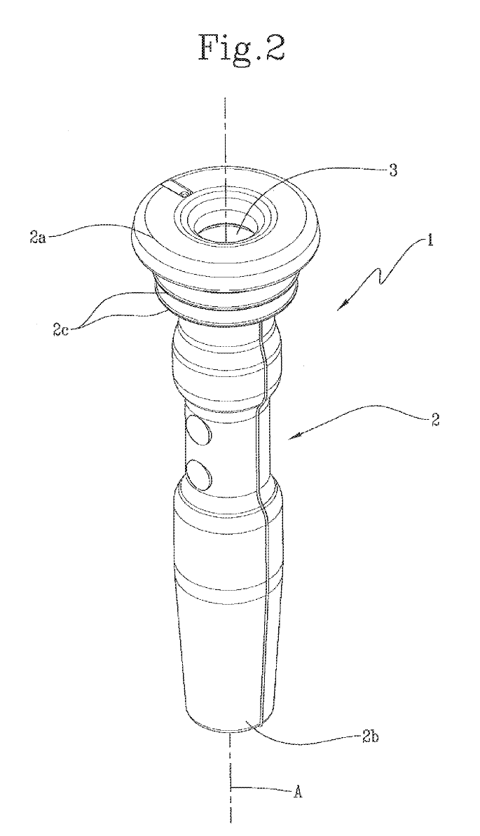

FIG. 2 shows a sectional view of an ignition coil for internal combustion engines installed according to the present invention.

With reference to the attached figures, the numeral 1 indicates a silicone extension for an ignition coil 100 for internal combustion engines, preferably for a pen or plug top coil.

Therefore, the ignition 1 coil 100 is a device configured to generate a spark inside each cylinder of the internal combustion engine, providing the two electrodes 101a of an ignition spark plug 101 with the voltage required to break the dielectric strength, allowing for the generation of a current flow.

Therefore, the coil 100, in use, is associated with a voltage (or current) generator device, preferably with the battery of the vehicle, and comprises a primary winding and a secondary winding.

These windings, along with all the electronic components and circuitry that allow for the generation of a high voltage on the secondary one, generically define electrical/electronic means 102 for the generation of high voltage electrical energy.

Hereinafter, this expression will be used to define these components, and possibly others related to them.

These electrical/electronic means 102 are housed in a container 103 or box-like body, which is preferably provided with a connecting protrusion 103a through which the electrical/electronic means 102 are brought into contact with the spark plug 101.

More precisely, the coil 100 comprises a connection conductive element 104 extending along its main direction “A” between a first end 104a connected to said electric/electronic means 102 and a second end 104b connected to said spark plug 101.

In particular, the second end 104b of the conductive element 104 is connected to the insulating body (101b) of the spark plug 101 opposite the two electrodes 101a.

Preferably, but not necessarily, the conductive element 104 is totally or partially defined by an electrically conductive helical spring.

In order to connect the container 103 to the spark plug 101, a silicone extension 1 as mentioned above is provided, which extends between the connecting protrusion 103a of the container 103 and the insulating body (101b) of the spark plug 101.

More precisely, the extension 1 comprises an elongated tubular body 2 extending along said main direction “A” between a first end portion 2a, shaped to be engaged in the container 103, and a second end portion 2b, shaped to accommodate the insulating body (101b) of an ignition spark plug 101.

Preferably, also, the first end portion 2a has, on its outer surface, one or more annular sealing lips 2c, which, in the working configuration, are inserted with slight forcing in a respective recess of the cylinder head of an internal combustion engine.

The tubular body 2 therefore has a longitudinal through cavity 3 preferably having a variable size cross section along its extension.

In particular, the cavity 3 has at least a first 3a and a second enlarged section 3b respectively placed at the first 2a and the second end portion 2b.

The first enlarged portion 3a is designed to accommodate the connecting protrusion 103a of the container 103.

More precisely, the first enlarged portion also comprises a sealing tooth that can be coupled with an undercut or engaging portion of the protrusion 103 to allow for the engagement thereof.

The second enlarged portion 3b, instead, is designed to accommodate the insulating body (101b) of the spark plug 101.

According to one aspect of the present invention, the tubular body 2 of the extension 1 is made of self-lubricating silicone rubber.

Preferably, the entire tubular body 2 is made (by moulding) of self-lubricating rubber.

Therefore, the tubular body 2 is made in one piece and extends monolithically between the first end portion 2a and the second end portion 2b.

In this light, the tubular body 2 defines the entire silicone extension and does not require further components to perform its function (other than optional, non-essential, additional and/or auxiliary components).

Advantageously, this eliminates the need to apply a lubricant on the insulating body of the spark plug prior to the engagement of the extension, thus simplifying the assembly procedure.

Moreover, a highly advantageous technical effect discovered by the Applicant lies in the capacity of the new self-lubricating silicone rubber to resist to the corona discharge effect so much better than the materials used in the prior art, which obviously translates into an increased durability and reliability of the extension.

More precisely, the self-lubricating silicone rubber of which the tubular body 2 is made has a composition comprising an oil content of between 0.5% and 10% by weight, more preferably between 1% and 6% by weight.

In the preferred embodiment, the silicone rubber used preferably has a composition comprising an oil content of between 1% and 5% by weight, preferably of about 3% by weight.

The expression “by weight” is intended to mean that a percentage comprised between the two ends of the range (preferably between 1% and 5%) of the mass of the tubular body is defined by the oil dispersed in the composition to make the rubber self-lubricating.

Preferably, the oil used is of the diathermic type.

Advantageously, in this way, the behaviour of the tubular body and its self-lubrication and resistance to the corona discharge effect properties remain unchanged even at the high temperatures reached by the coil during operation.

It should be noted that, in order to facilitate continuous lubrication of the material, the oil is homogeneously dispersed in the silicone rubber.

Further features of the silicone rubber of which the tubular body is made are its density equal to about 1.13 g/cm3 and therefore comparable to that of silicone rubbers hitherto used for similar applications.

Moreover, the performance of this rubber allows for significantly increasing:
the tear resistance, from about 30 N/mm of the prior art to 51 N/mm;
the tensile strength, from 8 MPa to 9.8 MPa;
the toughness, with a percentage elongation of 564 compared to 500 of the known silicone rubbers.

These properties, in some cases significantly enhanced, in others substantially unchanged, demonstrate that the material obtained for the manufacture of the tubular body 2 is equivalent in performance to those known as regards the mechanical and thermal resistance, with the important advantage of reducing the ageing effects and overcoming the corona discharge effect.

Also from the point of view of assembly and maintenance, moreover, the extension according to the present invention allows the process to be greatly simplified.

In fact, the method of assembling/installing the coil, which is also an object of the present invention, is spared of the expensive lubricant application step, notoriously poorly appreciated for cost and “cleaning” reasons.

Thus, the method according to the present invention involves connecting the first end 104a of the conductive element 104 to the electric/electronic means at the protrusion 103a of the container 103, inserting the conductive element 104 in the cavity 3 of the tubular body 2 of the silicone extension 1, and engaging the connecting protrusion 103a of the container 103 in the first end portion 2a of the tubular body 2.

Subsequently (but also simultaneously), the second end 104b of the conductive element 104 is connected to the terminal within the insulating body 101b of the spark plug 101, which is engaged in the second end portion 2b of the tubular body without the use of lubricants.

The invention achieves the intended objects and attains important advantages.

In fact, the use of a self-lubricating silicone rubber (preferably containing a quantity of diathermic oil comprised between 1% and 5%) for the manufacture of the silicone extension allows for eliminating the need to provide the lubricant on the insulating body of the spark plug and, mainly, for overcoming the corona discharge effect.

Moreover, the presence of oil inside the composition prevents the drying of the same and the consequent absorption of the external lubricant, allowing for a continuous supply of lubricant through a “bleeding effect”, which is why lubrication is ensured for a much longer time compared to extensions available on the market today, and the sticking problem is eliminated.

1. A silicone extension for an ignition coil for internal combustion engines, comprising an elongated tubular body extending along its main direction between a first end portion, shaped to be engaged in a container containing electrical/electronic means for the generation of high voltage electrical energy, and a second end portion shaped to accommodate the insulating body of an ignition spark plug;
wherein the tubular body is made of self-lubricating silicone rubber.

2. The silicone extension according to claim 1, wherein its composition comprises an oil content of between 0.5% and 10% by weight.

3. The silicone extension according to claim 2, wherein its composition comprises an oil content of between 1% and 6% by weight, preferably of about 3% by weight.

4. A silicone extension according to claim 1, wherein said oil is of the diathermic type.

5. A silicone extension according to claim 2, wherein said oil is dispersed homogeneously in the silicone rubber to facilitate a continuous lubrication of the material.

6. A silicone extension according to claim 1, wherein said tubular body has a longitudinal through cavity having a first enlarged section at its first end portion in order to house a connecting protrusion of a container containing electrical/electronic means for the generation of high voltage electrical energy.

7. A silicone extension according to claim 1, wherein said tubular body has a longitudinal through cavity having a second enlarged section at its second end portion in order to house the insulating body of an ignition spark plug.

8. A silicone extension according to claim 1, wherein the whole tubular body is made of self-lubricating silicon rubber.

9. An ignition coil for an internal combustion engine, comprising:
a container containing the electrical/electronic means for the generation of high voltage electrical energy;
a spark plug having a pair of electrodes and an insulating body;
a connection conductive element extending along the main direction between a first end connected to said electric/electronic means and a second end connected to said spark plug;
a silicone extension according to claim 1, wherein:
the container has a connecting protrusion engaged in said first end portion of the tubular body of the silicone extension;
the insulating body is engaged in said second end portion of the tubular body of the silicone extension;
said connection conductive element is housed in the cavity of the tubular body of the silicone extension.

10. A method of assembling and installing an ignition coil for an internal combustion engine, comprising the steps of:
providing a container containing electrical/electronic means for the generation of high voltage electrical energy having a connecting protrusion;
providing a spark plug having a pair of electrodes and an insulating body;
providing a connection conductive element extending along the main direction between a first end and a second end;
providing a silicone extension comprising an elongated tubular body extending along its main direction between a first end portion and a second end portion; said tubular body of the silicone extension being made of self-lubricating silicone rubber;
connecting said first end of the conductive element to said electrical/electronic means at said protrusion of the container;
inserting the conductive element in said cavity of the tubular body of the silicone extension;
engaging said connecting protrusion of the container in the first end portion of the tubular body of the silicone extension;
connecting said second end of the conductive element to the insulating body of the spark plug;
engaging, without the use of lubricants, the insulating body of the spark plug in the second end portion of the tubular body of the silicone extension.
